(19) United States
(12) Patent Application Publication
(10) Pub. No.: US 2011/0093793 A1
(43) Pub. Date: Apr. 21, 2011

(54) METHOD FOR ATTACHING DATA AND MOBILE TERMINAL THEREOF

(76) Inventor: Jae Hyung RYU, Seoul (KR)

(21) Appl. No.: 12/826,377

(22) Filed: Jun. 29, 2010

(30) Foreign Application Priority Data
Oct. 16, 2009 (KR) 10-2009-0098880

(51) Int. Cl. G06F 3/01

(52) U.S. Cl. 715/752; 715/835; 715/769

(57) ABSTRACT

A method controlling a mobile terminal, and which includes displaying, via a display included on the mobile terminal, a text message input window for creating a text message to be sent to at least one other terminal; receiving, via a controller included on the mobile terminal, a generation signal indicating first and second slides are to be generated for the text message, in which the first slide includes a first portion of the text message and the second slide includes a second portion of the text message; displaying, via the display, the first and second slides on first and second display portions of the display; displaying, via the display, a plurality of data to be attached to the first and second slides on a third display portion; receiving, via the controller, a selection signal indicating a selection of first and second data included in the displayed plurality of data; attaching, via the controller, the selected first and second data to the first and second slides; and transmitting, via a wireless communication unit, the text message including the first and second slides and the attached first and second data to the at least one other terminal.

### CROSS-REFERENCE TO A RELATED APPLICATION

The present application claims priority to Korean Application Number 10-2009-0098880, filed in Korea on Oct. 16, 2009, the disclosure of which is incorporated by reference herein in its entirety.

### BACKGROUND OF THE INVENTION

1. Field of the Invention

Embodiments of the present invention is related to a mobile terminal and corresponding method for attaching data attachments to text messages.

2. Discussion of the Background

Mobile terminals now provide many additional services beside the basic call service. For example, user's can now access the Internet, play games, watch videos, listen to music, capture images and videos, record audio files, etc. Mobile terminals also now provide broadcasting programs such that user can watch television shows, sporting programs, videos etc. In addition, mobile terminal also allows a user to send short text messages to other users. Sending text messages is thus becoming very popular, especially among younger people. However, the amount of data transmitted is limited to a predetermined number of characters, and the text message function is limited in capabilities.

### SUMMARY OF THE INVENTION

Accordingly, one object of the present invention is to address the above-noted and other problems.

Another object of the present invention is to provide a mobile terminal and corresponding method for easily creating text messages and attaching files to the created text messages.

To achieve these and other advantages and in accordance with the purpose of the present invention, as embodied and broadly described herein, the present invention provides in one aspect a method controlling a mobile terminal, and which includes displaying, via a display included on the mobile terminal, a text message input window for creating a text message to be transmitted to at least one other terminal; receiving, via a controller included on the mobile terminal, a generation signal indicating first and second slides are to be generated for the text message, and in which the first slide includes a first portion of the text message and the second slide includes a second portion of the text message; displaying, via the display, the first and second slides on first and second display portions of the display; displaying, via the display, a plurality of data to be attached to the first and second slides on a third display portion; receiving, via the controller, a selection signal indicating a selection of first and second data included in the displayed plurality of data; attaching, via the controller, the selected first and second data to the first and second slides; and transmitting, via a wireless communication unit, the text message including the first and second slides and the attached first and second data to the at least one other terminal.

In another aspect, the present invention provides a mobile terminal including a display configured to display a text message input window for creating a text message to be transmitted to at least one other terminal; a controller configured to receive a generation signal indicating first and second slides are to be generated for the text message, and in which the first slide includes a first portion of the text message and the second slide includes a second portion of the text message, to control the display to display the first and second slides on first and second display portions of the display and to display a plurality of data to be attached to the first and second slides in a third display portion, to receive a selection signal indicating a selection of first and second data included in the displayed plurality of data, to attach the selected first and second data to the first and second slides; and a wireless communication unit configured to transmit the text message including the first and second slides and the attached first and second data to the at least one other terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings, which are given by illustration only, and thus are not limitative of the present invention, and wherein:

FIG. 1 is a block diagram of a mobile terminal according to an embodiment of the present invention;

FIG. 2A is a front perspective view of a mobile terminal according to an embodiment of the present invention;

FIG. 2B is a rear perspective view of a mobile terminal according to an embodiment of the present invention;

FIG. 3 is a flowchart illustrating a method of controlling a mobile terminal according to an embodiment of the present invention;

FIG. 4 includes overviews of display screens illustrating a text message operation according to a first embodiment of the present invention;

FIG. 5 includes overviews of display screens illustrating a text message operation according to a second embodiment of the present invention;

FIG. 6 includes overviews of display screens illustrating a text message operation according to a third embodiment of the present invention; and

FIG. 7 includes overviews of display screens illustrating a text message operation according to a fourth embodiment of the present invention.

### DETAILED DESCRIPTION OF THE INVENTION

Hereinafter, a mobile terminal relating to embodiments of the present invention will be described below in more detail with reference to the accompanying drawings. Further, the mobile terminal described in the specification can include a cellular phone, a smart phone, a laptop computer, a digital broadcasting terminal, personal digital assistants (PDA), a portable multimedia player (PMP), a navigation system and so on.

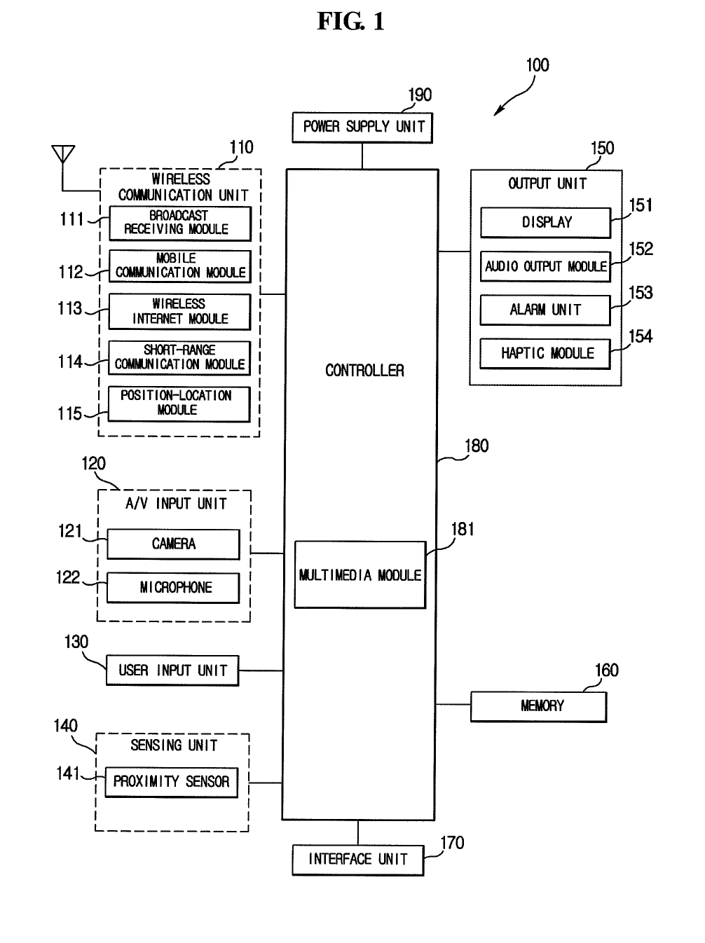

FIG. 1 is a block diagram of a mobile terminal 100 according to an embodiment of the present invention. As shown, the mobile terminal 100 includes a radio communication unit 110, an audio/video (A/V) input unit 120, a user input unit 130, a sensing unit 140, an output unit 150, a memory 160, an interface 170, a controller 180, and a power supply 190. Not all of the components shown in FIG. 1 are essential parts and the number of components included in the mobile terminal can be varied.

In addition, the radio communication unit 110 includes at least one module that enables radio communication between the mobile terminal 100 and a radio communication system or between the mobile terminal 100 and a network in which the mobile terminal 100 is located. For example, in FIG. 1, the radio communication unit 110 includes a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel. Further, the broadcasting channel can include a satellite channel and a terrestrial channel. Also, the broadcasting management server can be a server that generates and transmits broadcasting signals and/or broadcasting related information or a server that receives previously created broadcasting signals and/or broadcasting related information and transmits the broadcasting signals and/or broadcasting related information to a terminal. The broadcasting signals can include not only TV broadcasting signals, radio broadcasting signals and data broadcasting signals, but also signals in the form of a combination of a TV broadcasting signal and a radio broadcasting signal.

In addition, the broadcasting related information can be information on a broadcasting channel, a broadcasting program or a broadcasting service provider. The broadcasting related information can be provided even through a mobile communication network. In this instance, the broadcasting related information can be received by the mobile communication module 112. The broadcasting related information can also exist in various forms. For example, the broadcasting related information can exist in the form of an electronic program guide (EPG) of the digital multimedia broadcasting (DMB) system or in the form of an electronic service guide (ESG) of the digital video broadcast-handheld (DVB-H) system.

In addition, the broadcasting receiving module 111 receives broadcasting signals using various broadcasting systems. In particular, the broadcasting receiving module 111 can receive digital broadcasting signals using digital broadcasting systems such as the digital multimedia broadcasting-terrestrial (DMB-T) system, the digital multimedia broadcasting-satellite (DMB-S) system, the media forward link only (MediaFLO) system, and the DVB-H and integrated services digital broadcast-terrestrial (ISDB-T) system. The broadcasting receiving module 111 can also be constructed to be suited to broadcasting systems providing broadcasting signals other than the above-described digital broadcasting systems. The broadcasting signals and/or broadcasting related information received through the broadcasting receiving module 111 can also be stored in the memory 160.

Further, the mobile communication module 112 transmits/receives a radio signal to/from at least one of a base station, an external terminal, and a server on a mobile communication network. The radio signal can include a voice call signal, a video telephony call signal or data in various forms according to transmission and receiving of text/multimedia messages. The wireless Internet module 113 corresponds to a module for wireless Internet access and can be included in the mobile terminal 100 or externally attached to the mobile terminal 100. Wireless LAN (WLAN) (Wi-Fi), wireless broadband (Wibro), world interoperability for microwave access (Wimax), high speed downlink packet access (HSDPA) and so on can be used as a wireless Internet technique. The local area communication module 114 corresponds to a module for local area communication. Bluetooth, radio frequency identification (RFID), infrared data association (IrDA), ultra wideband (UWB) and ZigBee can be used as a local area communication technique.

In addition, the position information module 115 confirms or obtains the position of the mobile terminal 100. A global positioning system (GPS) module is a representative example of the position information module 115. Further, the GPS module 115 can calculate information on distances between one point (object) and at least three satellites and information on the time when the distance information is measured and apply trigonometry to the obtained distance information to obtain three-dimensional position information on the point (object) according to latitude, longitude and altitude coordinates at a predetermined time. Furthermore, a method of calculating position and time information using three satellites and correcting the calculated position and time information using another satellite is also used. In addition, the GPS module 115 continuously calculates the current position in real time and calculates velocity information using the position information.

Referring to FIG. 1, the AN input unit 120 is used to input an audio signal or a video signal and includes a camera 121 and a microphone 122. The camera 121 processes image frames of still images or moving images obtained by an image sensor in a video telephony mode or a photographing mode. The processed image frames can be displayed on a display 151 included in the output unit 150. In addition, the image frames processed by the camera 121 can be stored in the memory 160 or transmitted to an external device through the radio communication unit 110. The mobile terminal 100 can also include at least two cameras according to constitution of the terminal.

Further, the microphone 122 receives an external audio signal in a call mode, a recording mode or a speed recognition mode and processes the received audio signal into electric audio data. The audio data can also be converted into a form that can be transmitted to a mobile communication base station through the mobile communication module 112 and output in the call mode. The microphone 122 can employ various noise removal algorithms for removing noise generated when the external audio signal is received.

In addition, the user input unit 130 receives input data for controlling the operation of the terminal from a user. The user input unit 130 can include a keypad, a dome switch, a touch pad (constant voltage/capacitance), jog wheel, jog switch and so on. The sensing unit 140 senses the current state of the mobile terminal 100, such as an open/close state of the mobile terminal 100, the position of the mobile terminal 100, whether a user touches the mobile terminal 100, the direction of the mobile terminal 100 and acceleration/deceleration of the mobile terminal 100 and generates a detection signal for controlling the operation of the mobile terminal 100. For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can include a proximity sensor 141.

In addition, the output unit 150 generates visual, auditory or tactile output and in FIG. 1 includes the display 151, an audio output module 152, an alarm 153, and a haptic module 154. The display 151 displays information processed by the mobile terminal 100. For example, the display 151 displays a UI or graphic user interface (GUI) related to a telephone call when the mobile terminal is in the call mode. The display 151 also displays a captured or/and received image, UI or GUI when the mobile terminal 100 is in the video telephony mode or the photographing mode.

The display 151 can also include at least one of a liquid crystal display, a thin film transistor liquid crystal display, an organic light-emitting diode display, a flexible display and a three-dimensional display. Some of these displays can be of a transparent type or a light transmission type, which is referred to as a transparent display. The transparent display also includes a transparent liquid crystal display. The rear structure of the display unit 151 can also be of the light transmission type. According to this structure, a user can see an object located behind the body of the mobile terminal 100 through an area of the body of the mobile terminal 100, which is occupied by the display 151.

Further, the mobile terminal 100 can include at least two displays 151 according to constitution of the terminal. For example, the mobile terminal 100 can include a plurality of displays that are arranged on a single face at a predetermined distance or integrated. Otherwise, the plurality of displays can be arranged on different sides. In addition, when the display 151 and a sensor sensing touch (referred to as a touch sensor hereinafter) form a layered structure, which is referred to as a touch screen hereinafter, the display 151 can be used as an input device in addition to an output device. The touch sensor can be in the form of a touch film, a touch sheet and a touch pad, for example.

Also, the touch sensor can be constructed such that it converts a variation in pressure applied to a specific portion of the display 151 or a variation in capacitance generated at a specific portion of the display 151 into an electric input signal. The touch sensor can also be constructed such that it can sense pressure of touch as well as the position and area of touch. When touch input is applied to the touch sensor, a signal corresponding to the touch input is transmitted to a touch controller. The touch controller then processes the signal and transmits data corresponding to the processed signal to the controller 180. Accordingly, the controller 180 can detect a touched portion of the display 151.

Referring to FIG. 1, the proximity sensor 141 can be located in an internal region of the mobile terminal 100, surrounded by the touch screen, or near the touch screen. The proximity sensor 141 senses an object approaching a predetermined sensing face or an object located near the proximity sensor 141 using an electromagnetic force or infrared rays without having mechanical contact. Further, the proximity sensor 141 has a lifetime longer than that of a contact sensor and has wide application. The proximity sensor 141 also includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc.

In addition, a capacitive touch screen is constructed such that a proximity of a pointer is detected through a variation in an electric field according to the proximity of the pointer. In this instance, the touch screen (touch sensor) can be classified as a proximity sensor. For convenience of explanation, an action of approaching the pointer to the touch screen while the pointer is not in contact with the touch screen such that the location of the pointer on the touch screen is recognized is referred to as a “proximity touch” and an action of bringing the pointer into contact with the touch screen is referred to as a “contact touch” in the following description. Also, a proximity touch point of the pointer on the touch screen means a point of the touch screen to which the pointer corresponds perpendicularly to the touch screen when the pointer proximity-touches the touch screen.

Further, the proximity sensor 141 senses a proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can also be displayed on the touch screen.

Also, the audio output module 152 can output audio data received from the radio communication unit 110 or stored in the memory 160 in a call signal receiving mode, a telephone call mode or a recording mode, a speech recognition mode and a broadcasting receiving mode. The audio output module 152 also outputs audio signals related to functions (for example, a call signal incoming tone, a message incoming tone, etc.) performed in the mobile terminal 100. The audio output module 152 can include a receiver, a speaker, a buzzer, etc.

The alarm 153 outputs a signal for indicating a generation of an event of the mobile terminal 100. Examples of events generated in the mobile terminal 100 include receiving a call signal, receiving a message, inputting a key signal, inputting touch, etc. The alarm 153 can also output signals in forms different from video signals or audio signals, for example, a signal for indicating a generation of an event through vibration. The video signals or the audio signals can also be output through the display unit 151 or the audio output module 152.

In addition, the haptic module 154 generates various haptic effects that the user can feel. A representative example of the haptic effects is vibration. The intensity and pattern of vibration generated by the haptic module 154 can also be controlled. For example, different vibrations can be combined and output or sequentially output. The haptic module 154 can also generate a variety of haptic effects including an effect of stimulus according to an arrangement of pins vertically moving for a contact skin face, an effect of stimulus according to a jet force or sucking force of air through a jet hole or a sucking hole, an effect of stimulus of rubbing the skin, an effect of stimulus according to contact of an electrode, an effect of stimulus using an electrostatic force and an effect according to reproduction of cold and warmth using an element capable of absorbing or radiating heat in addition to vibrations. Further, the haptic module 154 can not only transmit haptic effects through direct contact but also allow the user to feel haptic effects through kinesthetic sense of his or her fingers or arms. The mobile terminal 100 can also include at least two or more haptic modules 154 according to constitution of the mobile terminal.

In addition, the memory 160 stores a program for the operation of the controller 180 and temporarily stores input/output data (for example, phone book, messages, still images, moving images, etc.). The memory 160 can also store data about vibrations and sounds in various patterns, which are output when a touch input is applied to the touch screen. The memory 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can also operate in relation to a web storage performing the storing function of the memory 160 on the Internet.

Further, the interface 170 serves as a path to all external devices connected to the mobile terminal 100. The interface 170 receives data or power from the external devices and transmits the data or power to the internal components of the mobile terminal 100 or transmits data of the mobile terminal 100 to the external devices. The interface 170 can also include a wired/wireless headset port, an external charger port, a wired/wireless data port, a memory card port, a port for connecting a device having a user identification module, an audio I/O port, a video I/O port, an earphone port, etc., for example.

In addition, an identification module is a chip that stores information for authenticating the authority to use the mobile terminal 100 and can include a user identify module (UIM), a subscriber identify module (SIM) and a universal subscriber identify module (USIM). A device (referred to as an identification device hereinafter) including the identification module can be manufactured in the form of a smart card. Accordingly, the identification device can be connected to the mobile terminal 100 through a port.

Also, the interface 170 can serve as a path through which power from an external cradle is provided to the mobile terminal 100 when the mobile terminal 100 is connected to the external cradle or a path through which various command signals input by the user through the cradle to the mobile terminal 100. The various command signals or power input from the cradle can be used as a signal for confirming whether the mobile terminal 100 is correctly set in the cradle.

The controller 180 controls the overall operation of the mobile terminal. For example, the controller 180 performs control and processing for voice communication, data communication and video telephony. In FIG. 1, the controller 180 includes a multimedia module 181 for playing multimedia. The multimedia module 181 can be included in the controller 180 or separated from the controller 180. Further, the controller 180 can perform a pattern recognition process capable of recognizing handwriting input or picture-drawing input applied to the touch screen as characters or images. In addition, the power supply 190 receives external power and internal power and provides power required for the operations of the components of the mobile terminal under the control of the controller 180.

Further, various embodiments of the present invention can be implemented in a computer or similar device readable recording medium using software, hardware or a combination thereof, for example. According to a hardware implementation, the embodiments of the present invention can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for executing functions. The embodiments can also be implemented by the controller 180.

According to a software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

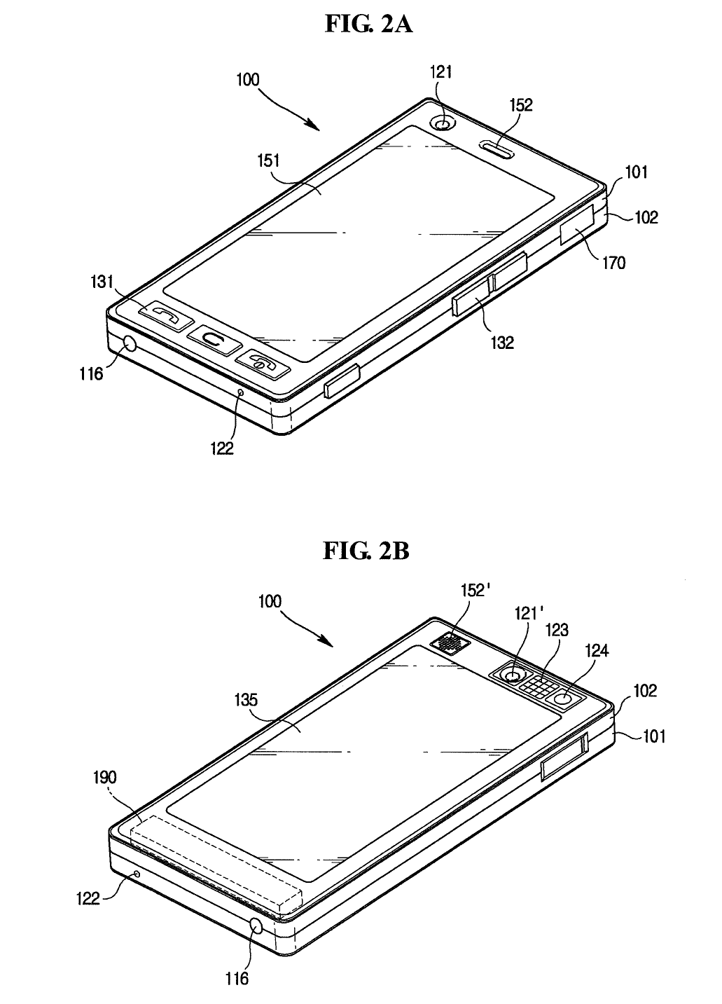

Next, FIG. 2A is a front perspective view of a mobile terminal or a handheld terminal 100 according to an embodiment of the present invention. As shown, the mobile terminal 100 is a bar type terminal body. However, the present invention is not limited to a bar type terminal and can be applied to terminals of various types including a slide type, folder type, swing type and swivel type terminals having at least two bodies that are relatively movably combined.

In addition, the terminal body includes a case (a casing, a housing, a cover, etc.) forming the exterior of the terminal 100. In the present embodiment, the case is divided into a front case 101 and a rear case 102. Various electronic components are also arranged in the space formed between the front case 101 and the rear case 102. At least one middle case can be additionally arranged between the front case 101 and the rear case 102. The cases can also be formed of plastics through injection molding or be made of a metal material such as stainless steel (STS) or titanium (Ti).

In addition, the display 151, the audio output unit 152, the camera 121, user input units 131 and 132 of the user input unit 130 (FIG. 1), the microphone 122 and the interface 170 are arranged in the terminal body, specifically, in the front case 101. Also, the display 151 occupies most part of the main face of the front case 101. The audio output unit 152 and the camera 121 are arranged in a region in proximity to one of both ends of the display 151 and the user input unit 131 and the microphone 122 are located in a region in proximity to the other end of the display 151. In addition, the user input unit 132 and the interface 170 are arranged on the sides of the front case 101 and the rear case 102.

Further, the user input unit 130 is operated to receive commands for controlling the operation of the handheld terminal 100 and can include the operating units 131 and 132. The operating units 131 and 132 can be referred to as manipulating portions and employ any tactile manner in which a user operates the operating units 131 and 132 while having tactile feeling. The operating units 131 and 132 can also receive various inputs. For example, the operating unit 131 receives commands such as start, end and scroll, and the second operating unit 132 receives commands such as control of the volume of sound output from the audio output unit 152 or conversion of the display 151 to a touch recognition mode.

Next, FIG. 2B is a rear perspective view of the mobile terminal 100 shown in FIG. 2A according to an embodiment of the present invention. Referring to FIG. 2B, a camera 121′ is additionally attached to the rear side of the terminal body, that is, the rear case 102. The camera 121′ has a photographing direction opposite to that of the camera 121 shown in FIG. 2A and can have pixels different from those of the camera 121 shown in FIG. 2A. For example, it is preferable that the camera 121 has low pixels such that it can capture an image of the face of a user and transmit the image to a receiving part for video telephony, while the camera 121′ has high pixels because it captures an image of a general object and does not immediately transmit the image in many instances. The cameras 121 and 121′ can also be attached to the terminal body such that they can be rotated or pop-up.

A flash bulb 123 and a mirror 124 are also arranged in proximity to the camera 121′. The flash bulb 123 lights an object when the camera 121′ takes a picture of the object, and the mirror 124 is used for the user to look at his/her face in the mirror when the user wants to self-photograph himself/herself using the camera 121′. An audio output unit 152′ is also provided on the rear side of the terminal body. The audio output unit 152′ can thus achieve a stereo function with the audio output unit 152 shown in FIG. 2A and be used for a speaker phone mode when the terminal is used for a telephone call.

A broadcasting signal receiving antenna 124 is also attached to the side of the terminal body in addition to an antenna for telephone calls. The antenna 124 constructing a part of the broadcasting receiving module 111 shown in FIG. 1 can be set in the terminal body such that the antenna 124 can be retracted from the terminal body. Further, the power supply 190 for providing power to the handheld terminal 100 is set in the terminal body. The power supply 190 can be included in the terminal body or detachably attached to the terminal body. A touch pad 135 for sensing touch is also attached to the rear case 102. The touch pad 135 can be of a light transmission type as the display 151. In this instance, if the display 151 outputs visual information through both sides thereof, the visual information can be recognized through the touch pad 135. The information output through both sides of the display 151 can also be controlled by the touch pad 135. Otherwise, a display is additionally attached to the touch pad 135 such that a touch screen can be arranged even in the rear case 102. The touch pad 135 also operates in connection with the display 151 of the front case 101. The touch pad 135 can be located in parallel with the display 151 behind the display 151, and can be identical to or smaller than the display 151 in size.

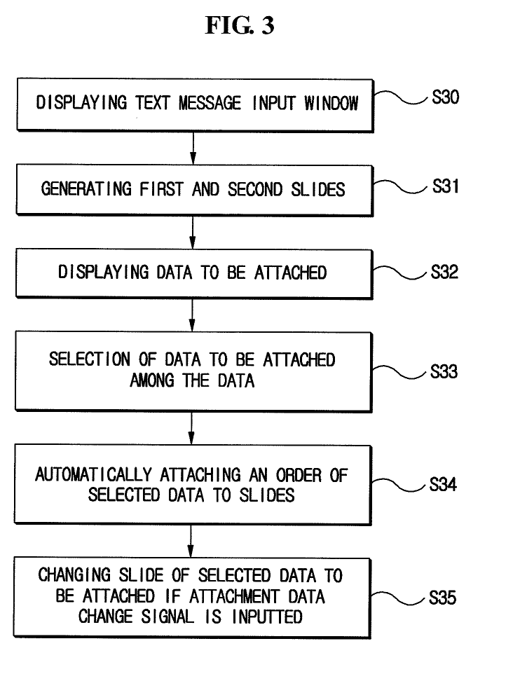

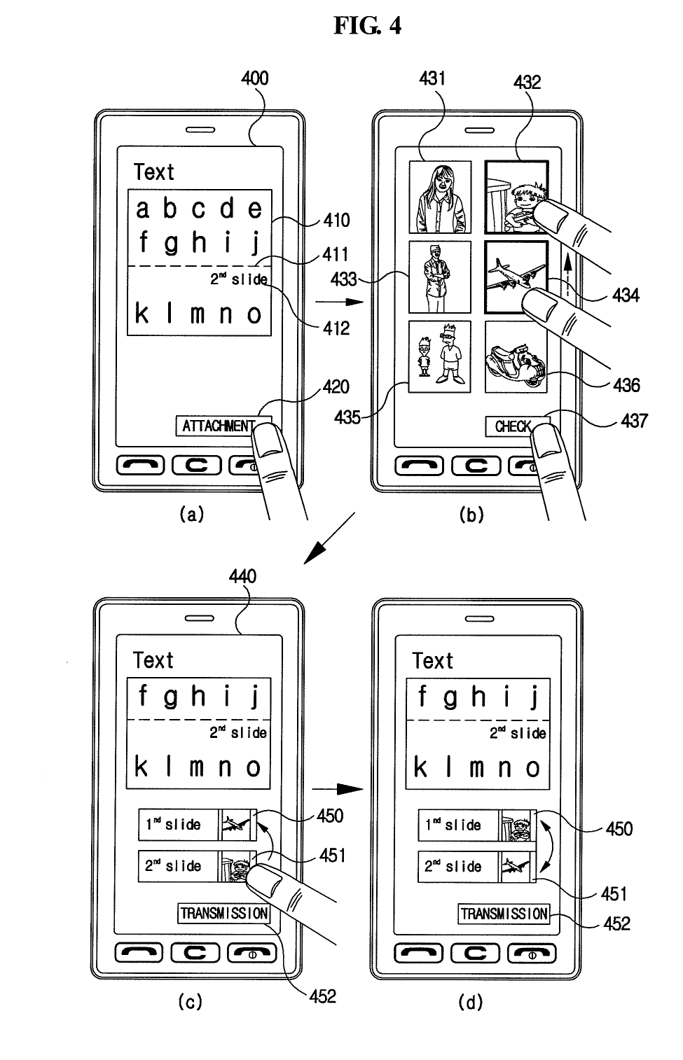

Next, FIG. 3 is a flowchart illustrating a method of controlling a mobile terminal according to an embodiment of the present invention. As shown, the controller 180 displays a text message input window when the user begins to send a text message (S30). Further, the text message input window may include a text input window, a data attachment window and the like. The user then manipulates the user input unit 130 to input the text message into the text message input window. Then, the controller 180 generates a first slide and a second slide including text input through the text message input window (S31). The first and second slides will be discussed in more detail later with respect to FIG. 4, for example, but refers to the controller 180 dividing the display into first and second display portions. The user can then enter text data in both of the first and second display portions or first and second slides. The first and second display portions can be on the same display or can be physically separated displays.

The user can also input a generation signal for instructing the controller 180 to generate the first and second slides through the user input unit 130. The controller 180 then generates the first slide including the message input before the user input generation signal, and the second slide for a message to be input after the user input the generation signal. In addition, the user can input the generation signal using a generation icon or menu displayed on the display 151, an exclusive input key (e.g., a hot key), etc. In an alternative embodiment, the controller 180 can automatically generate the first and second slides when a predetermined amount of text has been input into the first slide. In more detail, the controller 180 determines whether a capacity of a message input through the text message input window exceeds a predetermined capacity, and generates the first slide including a message within the predetermined capacity and the second slide including the text that has exceeded the predetermined capacity, when the capacity has been exceeded.

This is particular beneficial to the user because the amount of text that can be input is limited by the mobile service provider (e.g., limited to 150 characters). The user can also set the amount of text that can be input. Thus, if the user wanted to generate a text message that is greater than the limited 150 characters, the user can simply type in more characters and the controller 180 will automatically generate the number of slides needed. The user can also select a separate key to request a new slide be created as discussed above. Thus, if the amount of text that could be input is limited to 100 bytes, the controller 180 would display the message within the 100 bytes in the first slide, and display the message exceeding the 100 bytes into the second slide. Further, the slides include messages sendable at one time during a text message transmission and attached message(s).

Referring again to FIG. 3, when the user inputs a display signal for displaying data or attachments to be sent with the text message, the controller 180 extracts the stored data from the memory 160 and displays the extracted data on the display 151 (S33). Then, when the user selects particular attachments (S33), the controller 180 automatically and successively attaches the data to the first slide and the second slide in the order that the user has selected the attachments (S34). The controller 180 also displays the text message input window or slide and an attachment file window together on the display 151. Also, when the user inputs a data change signal for changing what attachments are assigned to what slides, the controller 180 changes the slide of the data to be attached according to the data change signal (S35). As a result, the user can easily attach data when messages are transmitted. Further, the controller 180 or the user can create more than two slides as needed. The user can also set the number of slides that are to be created using the appropriate menu options included on the mobile terminal.

Next, FIG. 4 includes overviews of display screens illustrating a text message operation according to a first embodiment of the present invention. In more detail, FIG. 4(a) illustrates the controller 180 displaying a text message input window 400 including a text input window 410 and an attachment icon 420. Hereinafter, the description will be given based on user selecting the attachment icon 420 for attaching data to a slide or slides, but the user can perform other methods for attaching data such as by selecting an attachment-only key (e.g., hot key), an attachment menu, touching or double-clicking an attachment, and the like.

Thus, as shown in FIG. 4(a), the user inputs text into the text input window 410 and when the amount of text input exceeds the predetermined capacity, the controller 180 creates the second slide allowing the user to continue entering text data. The controller 180 can also display text, a line, a figure, an icon, etc. to distinguishingly display the first and second slides. For example, as shown in FIG. 4(a), the controller 180 displays a line 411 and text 412 to distinguish the first slide from the second slide. Thus, the user can easily see the different slides. Further, as described above, the user or controller 180 can generate the first and second slides

Then, as shown in FIG. 4(b), when the user selects the attachment icon 420 in FIG. 4(a), the controller 180 extracts the stored data from the memory 160 and displays the data on the display 151. In this example, the displayed data 431-436 corresponds to images, but other types of data can also be displayed and attached (e.g., movies, MP3 files, etc.). The user can then select any of the displayed data to have the data attached to the slides. Further, in this embodiment, the data is attached to the slides based on the order the data is selected. For example, as shown in FIG. 4(b), the user first touches the data 434, then touches the data 432 and then touches the check icon 437. Thus, as shown in FIG. 4(c), the controller 180 attaches the data 434 to the first slide and attaches the data 432 to the second slide and displays the relationships between the slides and the attached data in windows 450 and 451. The user can also attach the data by simply touching the corresponding data (e.g., a long touch operation, a double touch operation, etc) rather than having to select the additional check icon 437.

As shown in FIGS. 4(c) and 4(d), the user can also change the order of the attached data. For example, the user can touch-and-drop an attached data file to change the order of the attached data. In FIG. 4(c), the user first touches the attached data in the window 451 and drags the data to the window 450. Thus, as shown in FIG. 4(d), the attached data files are reversed or changed. That is, the attachment file window 450 includes the data 432 and the attachment file window 451 includes the data 434. As a result, the user can easily attach the data when sending text messages and can easily see the different slides with the attached data. The user can then select the transmission icon 452, for example, to transmit the slides to the designated party.

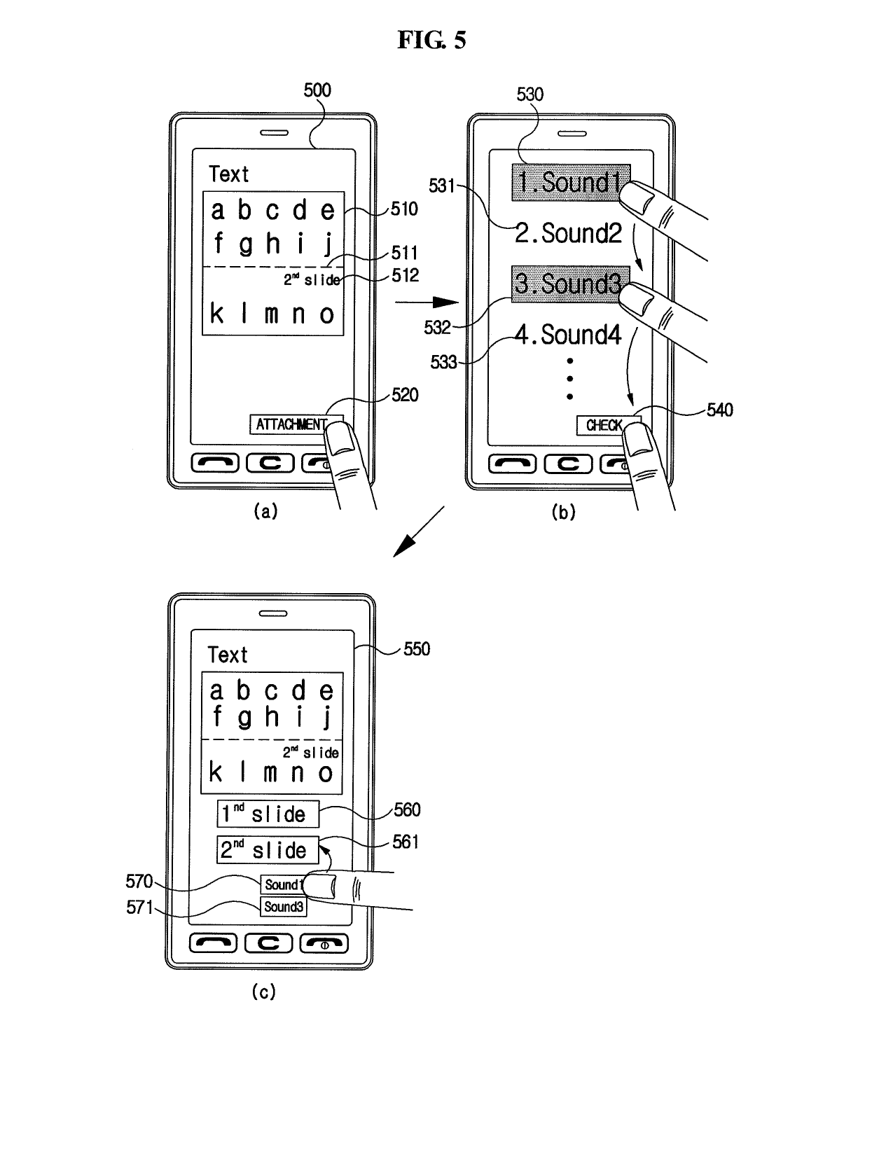

Next, FIG. 5 includes overviews of display screens illustrating a text message operation according to a second embodiment of the present invention. In particular, FIG. 5(a) illustrates the controller 180 displaying a text message input window 500 including an input window 510 and an attachment icon 520. Furthermore, the text message input window 500 includes a line 511 and text 512 for distinguishing the first slide from the second slide. This is similar to the features shown in FIG. 4(a). Then, when the user selects the attachment icon 520, the controller 180 extracts the stored data in the memory 160 and displays the data on the display 151, as shown in FIG. 5(b). Also, in this example, the data that can be attached are music files 530-533, but can be other types of data as discussed previously. Then, as shown in FIG. 5(b), the user successively touches the data 530 and 532 and then touches the check icon 540.

Then, as shown in FIG. 5(c), the controller 180 displays a window 550 including icons 570 and 571 representing the selected music data 530 and 532, respectively, and attachment file windows 560 and 561 representing the first and second slides, respectively. The user can then touch-and-drop one of the icons 570 and 571 to a desired slide. In FIG. 5(c), the user selects the icon 570 and drags the selected icon 570 to the second slide. Thus, in this example, the controller 180 would attach the sound 1 file 530 to the second slide. In an alternative example, when the user selects the check icon 540 in FIG. 5(b), the controller 180 can display a slide menu the user can use to select different slides. Then, the user uses the slide menu and attaches the data on the desired slide. As a result, the user can easily attach the data the desired slide.

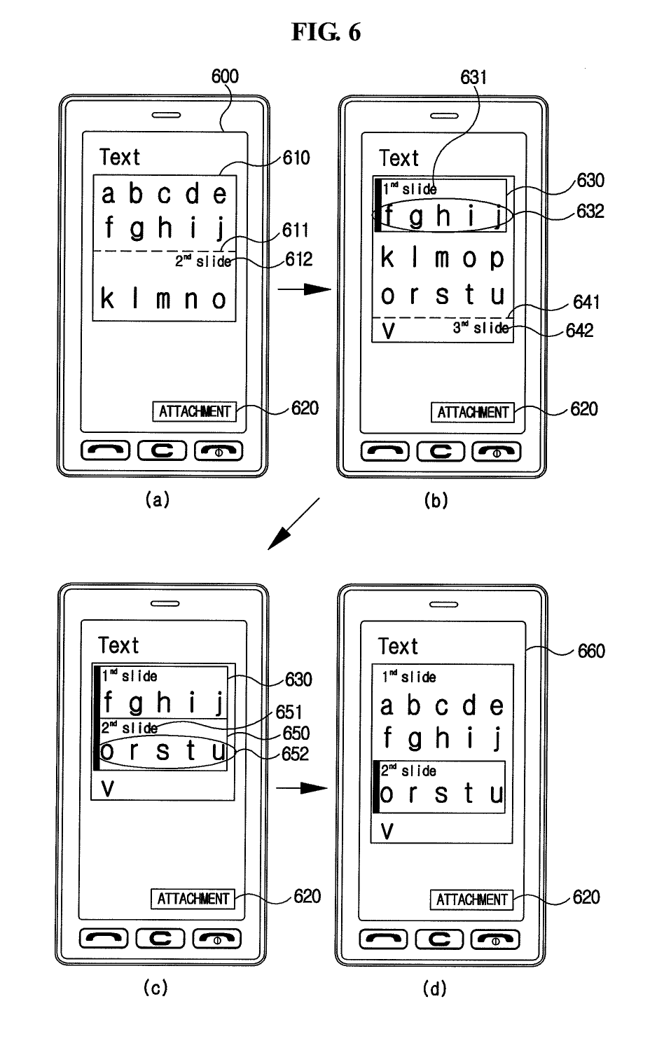

Next, FIG. 6 includes overviews of display screens illustrating a text message operation according to a first embodiment of the present invention. As shown in FIG. 6(a), when the user enters the text messaging mode, the controller 180 displays a text message input window 600 including a window 610 and an attachment icon 620. The user can then enter text into the text input window 610 using the user input unit 130. Further, the controller 180 determines whether the capacity of message input through the text message input window 610 exceeds a predetermined capacity, and displays a line 611 and text 612 for distinguishing the first slide from the second slide. Thus, the user has created two slides. When the user continues to input text that exceeds the predetermined capacity for the second slide, the controller displays a line 641 and text 642 for creating a third slide as shown in FIG. 6(b).

In addition, the controller 180 also displays only a portion 630 of the first slide in a window 630 so as to allow more space for the user to enter the second message. Then, when the text input into the second slide exceeds the predetermined capacity, the controller displays the line 641 and the text 642 for indicating a new third slide has been created, and as shown in the window 650 in FIG. 6(c), displays only a portion 652 of the text input in the second slide. Thus, the user has more space to enter text for the third slide. Thus, in one embodiment of the present invention, the controller 180 collapses the text input windows of previously generated slides to provide the user with more viewable space for entering the text message for the next slide. In this example, the only displayed portion corresponds to the last line of the text message in the first and second slides as shown in FIG. 6(c).

Then, when the user selects the window 630 in FIG. 6(c), the controller 180 displays the full text for that selected window as shown in FIG. 6(d). Thus, the user can view the full amount of input text for each slide, by individually selecting the slide. For example, the user can select the second slide in FIG. 6(d) to collapse the window for the first slide and display all of the text for the second slide. In addition, if all of the text input for an corresponding slide can not be displayed on one screen, the controller 180 can reduce the size of the font so all text can be displayed in one screen or provide pages of text that the user can flip through using a flicking operation (e.g., similar to flicking open pages of a book). As a result, the user can easily distinguish the different slides and grasp the contents included in the slides even if several slides are prepared.

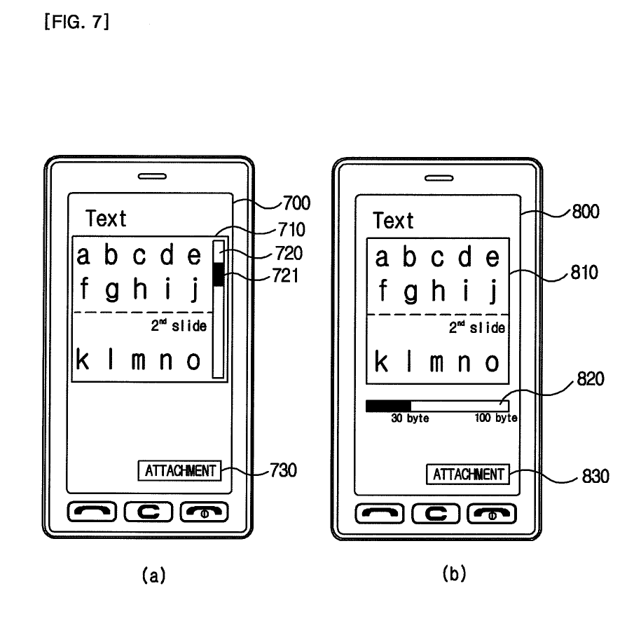

Next, FIG. 7 includes overviews of display screens illustrating a text message operation according to a fourth embodiment of the present invention. In particular, FIG. 7(a) is an overview of a display screen illustrating a text message input window 700 including a text input window 710, a scroll bar 720, a scroll indicator 721 and an attachment icon 730. The scroll indicator 721 displays a relative position of the data currently being displayed, whereby the user uses the scroll bar 720 and the scroll indicator 721 to easily scroll and view the position of the data that is displayed.

FIG. 7(b) is an overview of a display screen illustrating a text message input window 800 including a text input window 810, a progress bar 820 and an attachment icon 830. The progress bar 820 displays the capacity of messages that is currently being input. That is, the progress bar 820 includes ‘100 bytes’ that is a capacity of message that can be attached to one slide, and ‘30 bytes’ that is a capacity of the message currently being input. As a result, the user can easily grasp the position of the message that is currently being input.

In addition, the above-described methods can be implemented in a program recorded medium as computer-readable codes. The computer-readable media may include all kinds of recording devices in which data readable by a computer system are stored. For example, the computer-readable media include ROM, RAM, CD-ROM, magnetic tapes, floppy discs, optical data storage devices, and Internet transmission.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method controlling a mobile terminal, the method comprising:
displaying, via a display included on the mobile terminal, a text message input window for creating a text message to be sent to at least one other terminal;
receiving, via a controller included on the mobile terminal, a generation signal indicating first and second slides are to be generated for the text message, said first slide including a first portion of the text message and the second slide including a second portion of the text message;
displaying, via the display, the first and second slides on first and second display portions of the display;
displaying, via the display, a plurality of data to be attached to the first and second slides on a third display portion;
receiving, via the controller, a selection signal indicating a selection of first and second data included in the displayed plurality of data;
attaching, via the controller, the selected first and second data to the first and second slides; and
transmitting, via a wireless communication unit, the text message including the first and second slides and the attached first and second data to the at least one other terminal.

2. The method of claim 1, wherein the attaching step comprises:
attaching the selected first and second data to the first and second slides based on an order in which the first and second data are selected.

3. The method of claim 2, wherein the attaching step attaches the first data to the first slide and the second data to the second slide when the first data is selected first and the second data is selected second, and attaches the second data to the first slide and the first data to the second slide when the second data is selected first and the first data is selected second.

4. The method of claim 1, further comprising:
displaying, via the display, the selected first and second data and the generated first and second slides as icons.

5. The method of claim 4, wherein the attaching step attaches the first data to the first slide and the second data to the second slide when the first data is touched and dragged to the first slide and when the second data is touched and dragged to the second slide, and attaches the second data to the first slide and the first data to the second slide when the first data is touched and dragged to the second slide and when the first data is touched and dragged to the second slide.

6. The method of claim 1, further comprising:
determining, via the controller, whether a capacity of the text message input in the text message input window for creating the text message is greater than a predetermined capacity; and
generating the generation signal indicating the first and second slides are to be generated when the determining step determines the capacity of the text message input in the text message input window is greater than the predetermined capacity such that the displaying step displays the first and second slides on the first and second display portions of the display.

7. The method of claim 1, wherein the generation signal indicating the first and second slides are to be generated is a user input signal.

8. The method of claim 1, wherein the displaying the first and second slides comprises:
distinctively displaying the first and second slides by at least one of displaying a separation line separating the first and second slides and text indicating a name of the first and second slides, and displaying the first and second slides in the first and second display portions that are separated from each other.

9. The method of claim 1, further comprising:
collapsing the first slide when the second slide is generated such that only a portion of the text input in the first slide is visible and such that an area of the second slide is increased; and
collapsing the second side and un-collapsing the first slide upon receiving a selection signal indicating a selection of the first slide.

10. The method of claim 1, further comprising:
displaying, via the display, a progress bar indicating a maximum capacity of text that can be input for the created text message and a progress indicator indicating an amount of text that has so far been input for the created text message.

11. A mobile terminal, comprising:
a display configured to display a text message input window for creating a text message to be sent to at least one other terminal;
a controller configured to receive a generation signal indicating first and second slides are to be generated for the text message, said first slide including a first portion of the text message and the second slide including a second portion of the text message, to control the display to display the first and second slides on first and second display portions of the display and to display a plurality of data to be attached to the first and second slides in a third display portion, to receive a selection signal indicating a selection of first and second data included in the displayed plurality of data, to attach the selected first and second data to the first and second slides; and
a wireless communication unit configured to transmit the text message including the first and second slides and the attached first and second data to the at least one other terminal.

12. The mobile terminal of claim 11, wherein the controller is further configured to attach the selected first and second data to the first and second slides based on an order in which the first and second data are selected.

13. The mobile terminal of claim 12, wherein the controller is further configured to attach the first data to the first slide and the second data to the second slide when the first data is selected first and the second data is selected second, and attach the second data to the first slide and the first data to the second slide when the second data is selected first and the first data is selected second.

14. The mobile terminal of claim 11, wherein the controller is further configured to control the display to display the selected first and second data and the generated first and second slides as icons.

15. The mobile terminal of claim 14, wherein the controller is further configured to attach the first data to the first slide and the second data to the second slide when the first data is touched and dragged to the first slide and when the second data is touched and dragged to the second slide, and to attach the second data to the first slide and the first data to the second slide when the first data is touched and dragged to the second slide and when the first data is touched and dragged to the second slide.

16. The mobile terminal of claim 11, wherein the controller is further configured to determine whether a capacity of the text message input in the text message input window for creating the text message is greater than a predetermined capacity, and to generate the generation signal indicating the first and second slides are to be generated when the capacity of the text message input in the text message input window is determined to be greater than the predetermined capacity such that the display displays the first and second slides on the first and second display portions of the display.

17. The mobile terminal of claim 11, wherein the generation signal indicating the first and second slides are to be generated is a user input signal.

18. The mobile terminal of claim 11, wherein the controller is further configured to distinctively display the first and second slides by at least one of displaying a separation line separating the first and second slides and text indicating a name of the first and second slides, and to display the first and second slides in the first and second display portions that are separated from each other.

19. The mobile terminal of claim 11, wherein the controller is further configured to collapse the first slide when the second slide is generated such that only a portion of the text input in the first slide is visible and such that an area of the second slide is increased, and to collapse the second side and un-collapsing the first slide upon receiving a selection signal indicating a selection of the first slide.

20. The mobile terminal of claim 11, wherein the controller is further configured to control the display to display a progress bar indicating a maximum capacity of text that can be input for the created text message and a progress indicator indicating an amount of text that has so far been input for the created text message.
